(19) United States
(12) Patent Application Publication
(10) Pub. No.: US 2008/0085446 A1
(43) Pub. Date: Apr. 10, 2008

(54) System Made Up of Battery Units and Corresponding Terminal Connectors

(75) Inventors: Werner Schmidt, Naxxar (MT); Martin Florin, Bad Berleburg (DE)

Correspondence Address: Themis Intellectual Property Counsel, 7660 Fay Ave Ste H378, La Jolla, CA, 92037, US

(73) Assignee: ABERTAX RESEARCH & DEVELOPMENT, Paola (MT)

(21) Appl. No.: 11/577,717

(22) PCT Filed: Oct. 13, 2005
(86) PCT No.: PCT/EP05/55214

§ 371 Date: Aug. 30, 2007

(30) Foreign Application Priority Data
Oct. 29, 2004 (DE) 102004052831.4

(51) Int. Cl. H01M 2/20; H01M 10/48

(52) U.S. Cl. 429/90; 429/121

(57) ABSTRACT

In a system made up of battery units (2) and corresponding terminal connectors (10), the battery units may be combined in different ways in order to obtain larger battery groups. Each battery unit (2) has one surface that forms a terminal area (3) and that includes two terminals (6, 7), this surface having longitudinal edges (4) with a length (a), and lateral edges (5) with a width (b), (a) being equal or nearly equal to (2b), and the distance of each terminal (6, 7) to the longitudinal edges (4), as well as to the adjacent narrow edge (5) being equal or nearly equal to (b/2). A terminal connector (10) connects two terminals (6, 7) of adjacent battery units (2, 2′) and includes an electrical junction (12) having two connection points (16, 17) at its ends and a span equal or nearly equal to (b). Vertical connectors may be provided to interconnect terminals of battery units belonging to different layers of stacked up batteries.

The invention relates to a system made up of battery units and corresponding terminal connectors.

At present there are hundreds of battery types the terminal areas of which differ from each other with regard to size, aspect ratio, terminal position, pilers, elevators and the like. The multitude of battery types—in the following description the terms “battery” and “accumulator” as used as synonyms—causes the battery producer a lot of expenses for different equipment, manufacturing, storing, staff training, product literature and after-sales service. The industrial enterprises which need to install the batteries in apparatusses like wheel-chairs, fork lifters or electric vehicles or which need the batteries for stationary applications, are in a position to choose at the planning stage the optimal battery from among a lot of battery types, but as soon as the decision was made to use a certain battery type, only said battery type will have to be taken into consideration with regard to the subsequent phases of production, acquisition and supply of spare parts, which may cause problems in the long term. For example, in practice battery sizes of nominal standards are often not complied with such that there will be more or less great deviations from the standard dimensions. The end-user of the batteries will also be affected by these problems.

Moreover, the industry of electrical appliances and the end-users again and again are confronted by the problem that, caused by a conversion of production in the battery manufacturing industry or by farming out to other countries, it becomes more and more difficult and expensive, in the extreme case even impossible, to obtain the required battery type. In such situations, less-than-ideal solutions make it necessary to adapt the electric appliances to different battery types and to acquire other connecting parts suited for the new battery type.

It is an object of the invention to create a possibility for increasing the efficiency and for providing a standardization in utilizing batteries and accumulators.

This problem is resolved by a system made up of battery units and corresponding terminal connectors having the features of claim 1. Further convenient characteristics of the invention are set forth in the dependent claims.

The system according to the invention comprises battery units or accumulator units and corresponding terminal connectors. Each battery unit has a basic shape of a right parallelepiped one of its surface being a terminal area which is preferably the upper surface of the parallelepiped. The terminal area has a longitudinal edge with the length a and a narrow edge with the length (width) b and two terminals. There may be further terminals which, however, in this context are without any importance. According to the invention, the length a is equal or nearly equal 2b, and the distance between the two terminals and both the longitudinal and the adjacent narrow edge is equal or approximately equal b/2. In other words, the length of the terminal area is twice of its width, and the distance between both terminals is b such that they have a symmetric position on the terminal area.

Each terminal connector is adapted for the connection of two terminals of adjacent battery units and comprises an electrical junction having two connection points at its ends. According to the invention, the distance of both connection points is equal or nearly equal b. Said electric junction may be a flexible, sheathed cable comprising e.g. a metallic braid; Further possibilities are metal bars, e.g. rounds or flats which may have a gooseneck or stirrup shape with or without insulation. Said terminal connector can be coupled to a terminal by means of a connection point. Said connection points may have various forms. For example, the connection points may be in form of eyelets or bores drilled in a flat metal section such that screws may be inserted to fasten the terminal point to a terminal. In these cases the distance between both terminal points of a terminal connector is measured between the centers of said eyelets or bores.

The optimum geometry of the system according to the invention is that of a=2b, and the distance between both terminal points of a terminal connector is equal to b. However, slight differences are also covered by the claims if the basic idea of the invention is substantially realized, even though the space is utilized in a less optimal manner. Further, the battery unit may not have an exact parallelepiped basic shape and usually will have variances, e.g. smoothed off edges or reinforcing ribs.

The system according to the invention offers the possibility to avoid or at least reduce significantly the above mentioned difficulties. The battery units of the system may be positioned on a given area where they can be combined by means of a single connector type, which is that of the described terminal connector in order to obtain the combination of the basic battery units to create any multiple of tension and capacity of that basic battery unit. In order to multiply a tension, a desired number of battery units has to be connected in series by means of said terminal connectors, whereas the battery units have to be connected in parallel when the capacity should be increased. Also a mixed grouping is possible by a series-parallel coupling. As a result, only one single basic type of battery, i.e. the battery unit of the system, together with one connector type, i.e. that of the terminal connector of the system, are required in order to fulfill most of the conditions with regard to manufacture and use of electric devices like wheel-chairs, fork lifters or electric vehicles. In order to adapt the system to a variety of different applications, it may be useful to provide a variety of different structural sizes of battery units and terminal connectors, e.g. having different heights.

The battery unit suitably comprises a basic cell of the utilized type of a chemical battery which means that the tension between both terminals of said battery unit is the basic tension. Besides this it may be useful to combine in a battery unit a plurality of basic cells which may be coupled in series.

The above mentioned terminal connector offers the possibility to interconnect the battery units horizontally obtaining in this way larger battery groups. In order to make use of the third dimension of the space, according to a preferred characteristic of the invention, the battery units of the system may be piled up. In this case it is advantageous if the upper surface of each battery unit forms the terminal area provided with spacer elements that cooperate with corresponding counter parts located on the lower surface of a superimposed battery unit such that there is a gap between said upper surface and said lower surface which gap is used as a seat for the terminal connectors. In other words, said gap offers sufficient space to accommodate the terminal connectors. The counter parts located at the lower surface may be protruding legs engaging e.g. corresponding recesses provided in the upper surface of the lower battery unit, providing in this way a guard against shifting; in this case also said recesses are the mentioned “space elements”.

If two or more battery units are arranged in layers, the units within each layer being interconnected by the above mentioned terminal connectors, it may be in some cases required to interconnect some terminals of battery units belonging to adjacent layers. For this purpose the system according to the invention provides a further type of connector which is a vertical connector. The adjacent terminals of two adjacent and piled up battery units have a distance h. Said vertical connectors are adapted for the connection of said two terminals. Each vertical connector preferably has the basic shape of a stir with a central part and two arms protruding from the ends of said central par, each arm having at its free end a connection point. The length of the central part is equal or nearly equal to the distance h and the length of each arm up to its connection point is equal or nearly equal b/2. Dependent on the position of the vertical connector which may contact the outer wall of a battery unit or which may preferably engage a recess provided in the wall of the battery unit, the length of said arms may vary. Also the exact length of the central part depends on constructional details. The connection points of that vertical connectors should be such that they can be connected to the terminals of the battery units without causing excessive mechanical stresses.

According to a preferred embodiment of the invention, the interspace between the terminals of a battery unit and/or of the gap between the upper since of a battery unit and the lower surface of the superimposed further battery unit is adapted to contain devices for an electric or electronic monitoring and/or control. The space above the terminal area which is not required for current transmission may not only be used for devices which assist piling up the battery units (spacer elements cooperating with counter parts as described, e.g. also in the form of raised rims cooperating with corresponding counter parts), but also for accommodating electric or electronic devices for monitoring or controlling said battery units or said battery groups made up of a plurality of battery units, e.g. for the monitoring and/or control of battery parameters like voltage, current, temperature, gas pressure, charging status, number of charging cycles etc.

In the following some embodiments of the invention will be described which are illustrated in the drawing in which:

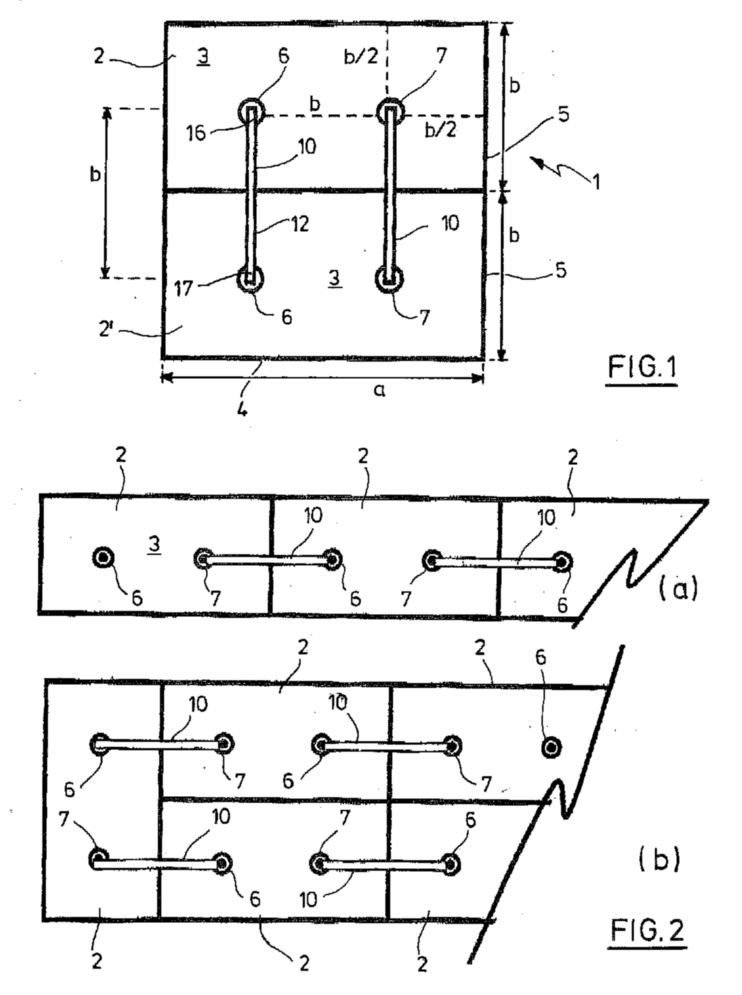

FIG. 1 is a plan view of two battery units placed in parallel and side-by-side,

FIG. 2 shows two plan views a and b of two different arrangements of battery units in serial connection,

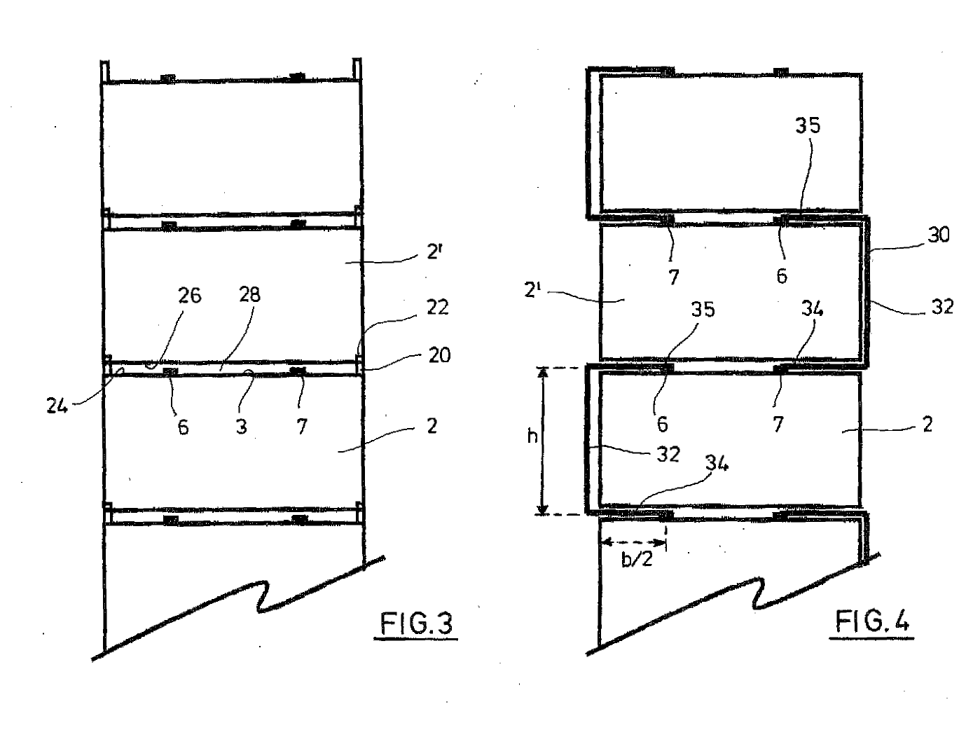

FIG. 3 is a lateral view of some piled up battery units,

FIG. 4 is a lateral view similar to that of FIG. 3 in which said battery units are interconnected in series by means of vertical connectors and

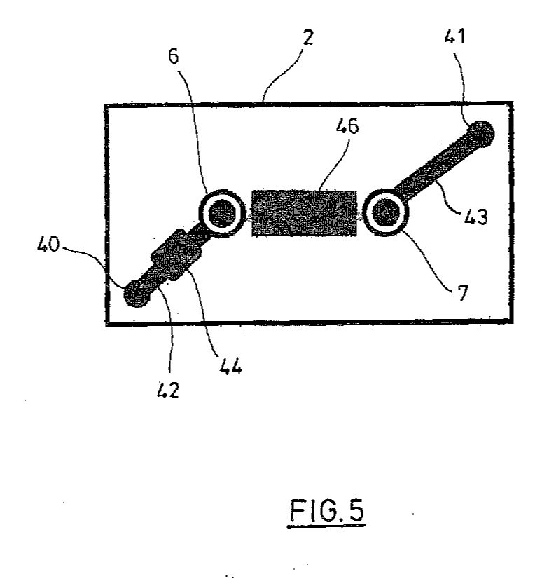

FIG. 5 is a schematic top view of an embodiment of the battery unit in which the covering of the casing has been removed.

FIG. 1 is a schematic top view of the component of the system 1. In this example, two battery units 2 and 2′ are placed side-by-side and are interconnected in parallel by means of two terminal connectors. The said battery unit 2 has the basic shape of a right parallelepiped the upper surface of which forms a terminal area 3. That terminal area 3 has a longitudinal edge 4 with a length a and a narrow edges 5 with a width b. On said terminal area 3 two terminals 6 and 7 are provided; in the example of FIG. 1, terminal 6 is the positive pole and terminal 7 is the negative pole. The distance of each terminal 6, 7 to the longitudinal edges 4 as well as to the adjacent narrow edge 5 is equal b/2. This means that the distance between both terminals 6, 7 is b referred to e.g. the axes of screw threads provided on the terminals 6 and 7.

As illustrated in FIG. 1, two battery units 2 are placed side-by-side, wherein the lower unit in FIG. 1 has the reference number 2′. As both battery units 2 and 2′ are identic, the further reference numbers will not differ from each other. Both terminals 6 are interconnected by means of a terminal connector 10. In the illustrated embodiment the terminal connector 10 is made up of a flat metal bar 12 the ends of which are enlarged and form eyelets such that they constitute connection points 16 and 17 having through bores (the centers of the eyelets). The distance between the connection points 16 and 17 is b, referred to the axes of said bores. In the embodiment, the terminal connector 10 is fastened to each of said terminals 6 by means of a screw nut. An identic terminal connector 10 interconnects the terminals 7 of both battery units 2 and 2′, i.e. the negative poles. As mentioned above, other types of terminal connectors are possible.

According to the example of FIG. 1, both battery units 2 and 2′ are connected in parallel. In this way a battery group is realized having the tension of each of the battery units 2, but in which each single battery unit 2 has twice the charging capacity of each of the battery units 2 and supplies twice the current.

FIG. 2 illustrates a further arrangement of battery units 2 which are positioned on the same level and which are interconnected by terminal connectors 10. En part a of FIG. 2 the illustrated group of batteries is a row, whereas in part b there are two rows of battery units 2. In both cases the terminal 6 (positive pole) of one battery unit 2 is connected to terminal 7 (negative pole) of the adjacent battery unit 2 such that the battery units 2 are connected in series. This means, that the total tension between the free terminals of the last battery member 2 is a multiple of the tension of each single battery unit 2.

FIG. 3 illustrates a battery group comprising a number of piled up battery units 2. In order to facilitate stacking of said battery units 2, a number of spacer elements 20 protrude from the upper surface (terminal area 3) of each battery unit 2 engaging corresponding recesses 22 provided in the lower surface of the superimposed battery unit 2′. In this way, the battery units 2, 2′ cannot shift to each other. Between the upper surface 24 of the battery unit 2 and the lower surface 26 of the battery unit 2′ there is a gap 28 such that there is sufficient space to interconnect the battery units 2 of a determined layer by means of terminal connectors 10 as illustrated in FIGS. 1 and 2. Further, said gap 28 may be used as a seat for electronic components which may be used to monitor the single battery units 2 or the whole battery group.

In order to create a greater variability for the connection possibilities, the system comprises further vertical connectors 30 in order to interconnect the terminals of battery units 2 in adjacent layers of the battery block. This is illustrated in FIG. 4.

Each vertical connector 30 has the basic shape of a stirrup which comprises, when mounted, a vertical central part 32 and to arms 34 and 35. The length of the central part 32 is h which corresponds to the distance between adjacent terminals of two directly superimposed battery units 2 and 2′ or which corresponds approximately to that distance. The free ends of the arms 34 and 35 are connection points similar to those of the terminal connector 10, and may be fastened to the terminal 6 or 7 respectively by means of screw nuts. FIG. 4 illustrates an arrangement in which the battery units 2 and 2′ are connected in series.

The length of each arm 34, 35 is equal or nearly equal b/2. In the embodiment of FIG. 4, the arms 34, 35 are slightly longer. If the central part 32 of a vertical connector 30 engages a recess provided in the wall of a battery unit 2, the length of the arms 34, 35 may be slightly less than by 2.

FIG. 5 illustrates schematically the upper surface (terminal area 3) of a battery unit 2 from which the covering has been removed. The terminals 6, 7 are not positioned directly in alignment with the electric accesses 40, 41 respectively of the corresponding battery cell of the battery unit 2 (which in this example is made up of a plurality of basic cells), but are staggered to them. The linkage between the terminals 6, 7 and the accesses 40, 41 is realized by means of electric connectors 42 and 43. In the example, the electric connector 42 is provided with a shunt which is adapted to gain information to be used for the monitoring and control of the battery unit 2. Further, an electronic unit 46 is provided between the terminals 6 and 7 which is used to monitor or control the battery unit. Said electronic unit 46 may also be positioned above the covering of the casing. The electric interconnections of said electronic unit 46 and the terminals 6 and 7 and the shunt 44 are not illustrated in FIG. 5.

What is claimed is:

1. A system comprising:
a plurality of battery units (2); and
a plurality of terminal connectors (10),
wherein each of the battery units (2) has a surface forming a terminal area (3),
wherein the terminal area (3) comprises two terminals (6,7), the terminal area having longitudinal edges (4) with a length (a) and lateral edges (5) with a width (b), the length being substantially equal to twice the width, the distance of each terminal (6, 7) to one longitudinal edges (4) and to one adjacent lateral edge (5) being substantially equal to half the width, and
wherein a terminal connector (10) connects two terminals (6, 7) of adjacent battery units (2, 2′), the terminal connector (10) comprising an electrical junction (12) having a first and a second connection points (16, 17), the distance between the first and the second connection point being substantially equal to the width (b).

2. The system according to claim 1, wherein the battery units (2) are stackable.

3. The according to claim 2, wherein the surface forming the terminal area (3) is the upper surface of each battery unit and is provided with spacer elements (20) cooperating with mating parts (22) of a lower surface (26) of a superimposed battery unit (2′), and
wherein a gap (28) is present between said upper surface (24) and said lower surface (26), the terminal connectors (10) extending into the gap.

4. The system according to claim 3, wherein the terminals (6, 7) of two adjacent and stacked up battery units (2, 2′) have a distance (h), and wherein vertical connectors (30) are provided for connecting said terminals (6, 7) of said two adjacent and stacked up battery units (2, 2′).

5. The system according to claim 4, wherein walls of said battery units (2) are provided with recesses for receiving said vertical connectors (30).

6. The system according to claim 4, wherein the gap (28) contains a device for monitoring and/or controlling the adjacent and stacked up battery units.

7. The system according to claim 1, wherein at least one of the terminals (6, 7) is not aligned with an electric access (40, 41) into a cell of the battery unit but is staggered in relation to the electric access, and wherein an electric connector (42, 43) connects the at least one of the terminals with the electric access.

8. (canceled)

9. The system according to claim 4, wherein each vertical connector (30) is substantially shaped like a stirrup having a central part (32) and two arms (34, 35), wherein each of the two arms (34, 35) extends from an end of the central part (32) and includes a connection point, and wherein the length of the central part (32) is substantially equal to the distance (h) and the length of each arm (34, 35) up to the connection point is substantially equal to half of the width.

10. The system according to claim 1, wherein an interspace between the terminals (6, 7) contains a device for monitoring and/or control of the battery unit.

11. The system according to according to claim 7, wherein the electric connector is provided with a shunt (44).

12. The system according to claim 11, wherein the shunt (44) collects information for monitoring and controlling the battery unit (2).

13. The system according to claim 1, wherein two of the adjacent battery units are adjacent along one of the longitudinal edges.

14. The system according to claim 1, wherein two of the adjacent battery units are adjacent along one of the lateral edges.

15. The system according to claim 1, wherein two of the adjacent battery units are adjacent along one of the longitudinal edges and are each adjacent to one of the longitudinal edges of a third battery unit along one of the lateral edges.
